(19) United States
(12) Patent Application Publication
(10) Pub. No.: US 2016/0002974 A1
(43) Pub. Date: Jan. 7, 2016

(54) LED WINDOW BLINDS WITH WARM DIMMING CAPABILITY

(71) Applicant: GE Lighting Solutions, LLC, East Cleveland, OH (US)

(72) Inventor: Olivia Rae BOYLE, East Cleveland, OH (US)

(21) Appl. No.: 14/324,781

(22) Filed: Jul. 7, 2014

(51) Int. Cl. E06B 9/386

(52) U.S. Cl. CPC E06B 9/386; E06B 2009/247

(57) ABSTRACT

A window blinds assembly includes a slat member, and a LED light strip coupled to the slat member. The light from the LED light strip projects through the slat member.

### BACKGROUND

The present disclosure generally relates to light emitting diode (LED) lighting, and more particularly to a window covering incorporating LED lighting.

Window coverings, and in particular window blinds, are generally understood to be used to control the amount of light that is allowed to pass from a lighted environment to another environment, typically through a window. One of the most common applications for such blinds is in conjunction with a window for a room, where the amount of light that passes from the outside to into the room is controlled by the position of the blinds.

The typical window blind is in the form of a slat or a similar singular thin plate material. The thin plate material can be hollow or solid, or a combination thereof, depending upon the particular application. The blinds are coupled together with pull cords to form window blinds. Windows blinds can come in many forms, the most typical being vertical, horizontal and roll-up types of blinds.

FIG. 1 illustrates a conventional horizontal blind arrangement 100. In this example, the horizontal blind arrangement 100 includes a number of slats 2 that are equally spaced apart. The slats 2 are suspended between an upper member 4 and a lower member 6. The upper member 4 can generally comprise an attachment member that is used to couple the blind arrangement 100 to the window or other opening. A rope ladder arrangement 8 can be used to couple the slats 2 together. The particular number of slats 2 will depend upon the application and the size of the window or opening that is intended to be covered. A pull cord 10 passes through cord-passage holes 12 in the slats 2. A handle end 16 of the pull cord 10 is used to raise and lower the slats 2, the pull cord 10 being wound around a pulley 14 in this example, which is disposed in the channel 18 of the upper attachment member 4.

LED light strips come in a variety of different packages and configurations. The LED light strips tend to be flexible and can accommodate any desired number of LED lights. One example of such an LED light strip, also referred to as a sheet is the COOLEDGE™ light sheet manufactured by Cooledge Lighting of Burnaby, BC. This light sheet is a thin, flexible LED strip that combines the mechanical, electrical and LED sources into a flexible sheet of light. The light sheet utilizes a highly dense pattern of LED's on a plastic substrate. The COOLEDGE™ light sheet is just one example of such light strips.

FIG. 2 illustrates one example of an exemplary light strip or sheet 200. In this example, one or more LEDs 202 are disposed on a thin flexible sheet 204. The particular arrangement of the LEDs 202 on the thin sheet 204 is merely exemplary, and in alternate embodiments, the LEDs 202 can be arranged in any suitable manner. Electronics 206 for driving the LEDs 202 and establishing electrical connections between and among the LEDs are also shown in this example. The power and electrical connections to and between the LEDs 202 will be made in a manner that is generally understood.

The thin sheet 204 is generally comprised of a thin film plastic material that is flexible. The strips or sheet 200 can come in a variety of configurations, including top emitting LEDs, as shown in FIG. 2, or side emitting. The colors of the LEDs 202 can also vary depending upon the particular application.

There is a continued emphasis on incorporating artificial light into a room in a space efficient and economical fashion. One particular aspect of light therapy involves gently waking a person from sleep by gradually increasing the intensity of the light in the room, similar to a sunrise-like sequence of lighting. This is especially useful during time periods and in time zones where there is little or no morning light.

Accordingly, it would be desirable to provide a lighting solution for a home that addresses at least some of the problems identified above.

### BRIEF DESCRIPTION OF THE INVENTION

As described herein, the exemplary embodiments overcome one or more of the above or other disadvantages known in the art.

One aspect of the exemplary embodiments relates to a window blinds assembly. In one embodiment, the window blinds assembly includes a slat member, and a LED light strip coupled to the slat member. The light from the LED light strip projects through the slat member.

Another aspect of the disclosed embodiments is directed to a window blinds assembly for a window. In one embodiment the window blinds assembly includes a light diffuser element; an LED strip coupled to the light diffuser element and configured to project light through the light diffuser; a pull cord assembly for raising and lowering the window blinds assembly, the pull cord assembly being coupled to the light diffuser element; an attachment member for coupling the window blinds assembly to a frame portion of the window, the attachment member including a channel for housing a power supply for the LED strip; and an electrical connection in the pull cord assembly coupling the LED light strip to the power supply.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a perspective view of an exemplary horizontal blind system of the prior art.

FIG. 2 is a top plan view of an exemplary LED light strip or sheet of the prior art.

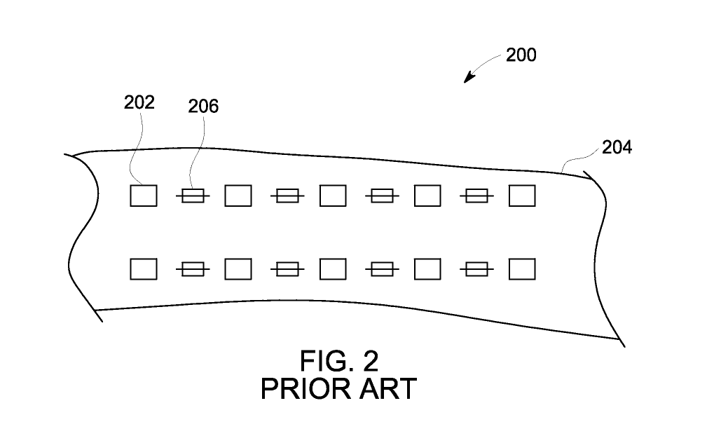

FIG. 3 is a perspective front view of a window blind assembly incorporating aspects of the disclosed embodiments.

FIG. 4 is a side view of the window blind assembly of FIG. 3.

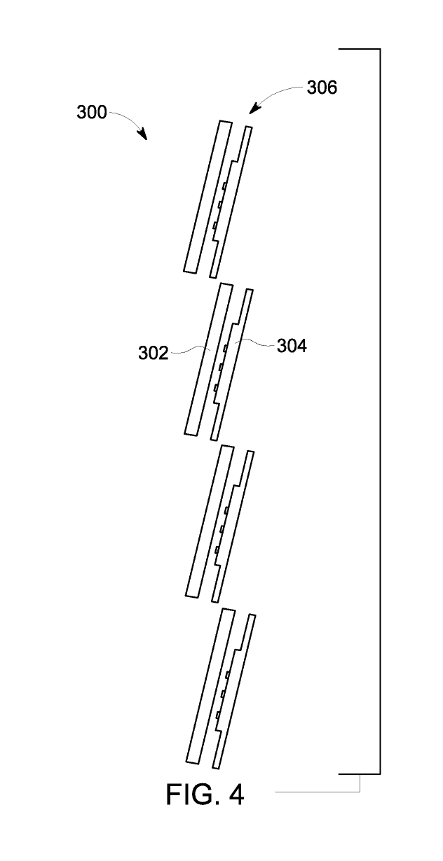

FIG. 5 is a schematic block diagram of one aspect of a window blind assembly and system incorporating aspects of the disclosed embodiments.

### DETAILED DESCRIPTION OF THE EXEMPLARY EMBODIMENTS OF THE DISCLOSURE

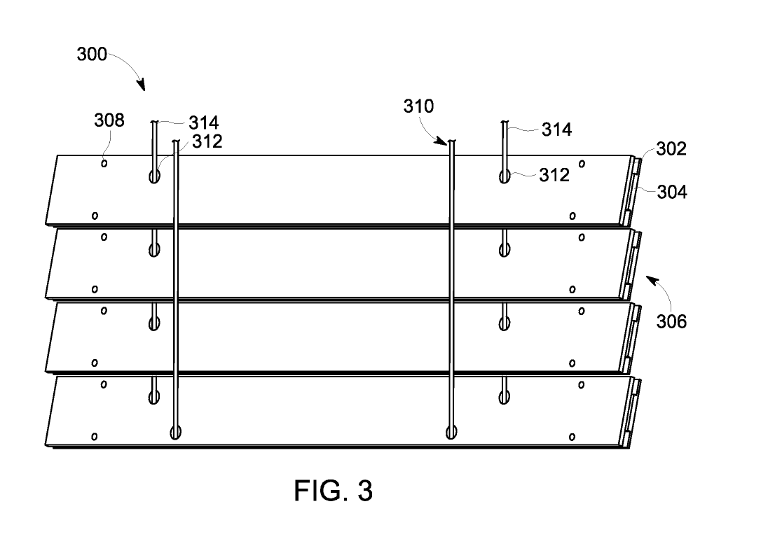

Referring to FIG. 3, an exemplary window covering such as a window blind assembly in accordance with the aspects of the disclosed embodiments is generally designated by reference numeral 300. The aspects of the disclosed embodiments are directed to a window blind assembly that incorporates LED lighting. In the exemplary embodiment, one or more LED light strips or sheets are incorporating into the window blind assembly 300 to provide lighting. Although the aspects of the disclosed embodiments are generally described herein with respect to a window blind, in alternate embodiments the window covering can include any window covering assembly that can have a LED light strip or sheet mounted thereon.

As is shown in FIG. 3, the window blind assembly 300 includes a number of substantially flat members, also referred to as slats 302. As is generally understood, the slats 302 may comprise long thin members that are attached together to form window blinds. The slats 302 can be hollow or solid members, or a combination thereof In the example shown in FIG. 3, the vertical orientation of the individual slats 302 can be varied between approximately 180 degrees to about −180 degrees to expose the opening, or window, that the window blind assembly 300 is covering. In this example, four slats 302 are shown, although in alternate embodiments, the window blind assembly 300 can include any suitable number of slats 302, including more or less than four.

Although the slats 302 are generally described and shown herein as individual members, in alternate embodiments the slats 302 can be formed of a single or contiguous member. For example, in one embodiment, the slats 302 can be formed of a flexible material, such as a fabric, that can fold up onto itself In this example, the positions of the individual slats 302 cannot be substantially varied. Rather, the entire window blind assembly 300 must be raised to expose the opening that the window blind assembly 300 is covering. When the window blind assembly 300 is raised, the slats 302 can fold into each other to form a compact or folded window blind assembly 300.

In the example of FIG. 3, the slat 302 forms a light diffuser element. The light diffuser element can comprise any suitable light diffuser that is flexible and will allow the slat 302 to appear as a typical window blind. The slat 302, or light diffuser element, is combined with an LED light strip or sheet 304 to create a long, thin blind 306. The LED light strip 304 in this example can comprise a 7 millimeter (1.1 inch) COOLEDGE™ light sheet. In alternate embodiment, any suitably sized LED light strip or sheet can be used.

In one embodiment, the slat 302 and LED light strip 304 is coupled together using an attachment device 308. The attachment device 308 comprises any suitable coupling mechanism that couples the slat 302 and LED light strip 304 together in a secure manner. For example, in one embodiment, the attachment device 308 comprises a pin that secures the slat 302 and the LED light strip 304 together, while maintaining any needed distance between the slat 302 and the LED light strip 304. The blinds 306 will then be attached or coupled together to form the window blind assembly 300.

In one embodiment, the electrical and power connections of the LED light strip 304 can be coupled to or comprise part of the pull cord assembly 310 or string element that is used to control the position of the blinds 306. The pull cord assembly 310 generally comprises a pull cord 314 that extends through openings 312, and is used to position the blinds 306 up or down to expose or cover the corresponding opening or window. For example, the electrical connections or wires needed for the LED light strip 304 can be part of or form the cord 314 that forms part of the pull cord assembly 310.

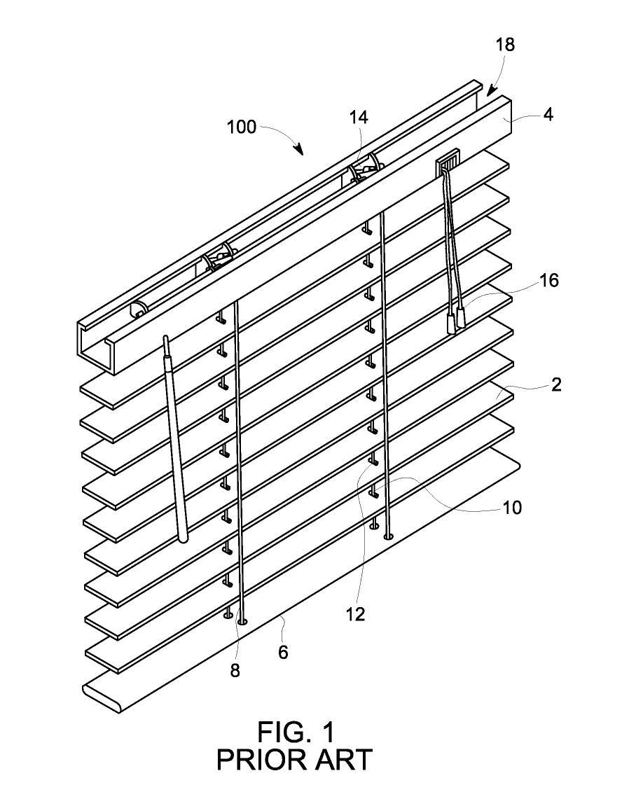

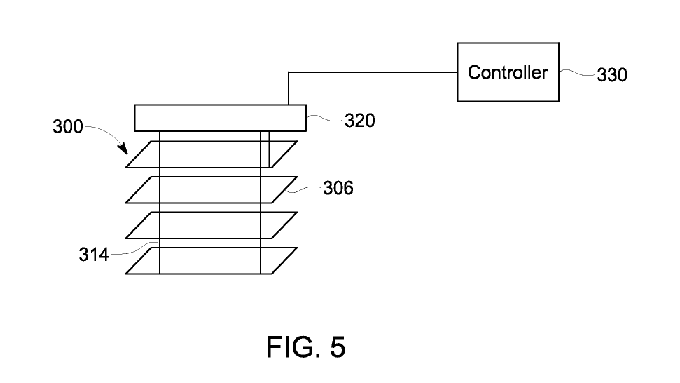

In one embodiment, the ballast (not shown) for the LED light strip 304 of the window blinds assembly 300 can be disposed in the portion of the window blinds assembly 300 that is used to secure the window blinds assembly 300 to the opening or window. Although not shown in FIG. 3, an example might be the upper attachment member 4 illustrated in the example of FIG. 1 or the attachment member 320 shown in FIG. 5. As more clearly shown in the example of FIG. 1, there is an opening or channel 18 in the attachment member 4 that can be used to retain or house the ballast and any other required electronics. A power cord, not shown, can be routed from ballast in the channel 4 to a suitable electrical power source or supply.

The window blind assembly 300 shown in FIG. 3 can generally be described as a horizontal blind assembly. In alternate embodiments, the window blind assembly 300 can include other suitable blind arrangements including a horizontal blind assembly and a roll-up blind assembly.

The aspects of the disclosed embodiments enable warm dimming to be incorporated into illuminating a space in addition to using a natural source (window) for illumination. In one embodiment, the light sheet 304 can comprise a mix of warm and cool white LEDs in a single sheet. Referring to FIG. 5, a control system 330, such as a controller, can be coupled to the window blinds assembly 300 to control when and how the LED light strips 304 are powered ON and OFF. The controller 330 can comprise any suitable control mechanism, such as a computer, microprocessor or other processing device. The controller 330 will generally be configured to control the operations and illumination of the LED light strips 304 in any desired manner. For example, in one embodiment, the controller 330 can be configured to control the LED light strips 304 of the window blinds assembly 300 to achieve an artificial sunrise effect to wake consumers up, as well as a warm dimming to imitate a sunset.

The aspects of the disclosed embodiments provide a unique lighting solution by utilizing LED light strips or sheets combined with diffusers that are incorporated into a window blinds assembly to provide illumination. The LED light strips and diffusers are combined to form the blinds. The LED light strips can be controlled to provide illuminations and warm dimming control. The illumination and warm dimming control can provide an artificial sunrise effect as well as a sunset effect. Different lighting effects can be provided by providing LED light strips of different colors and well as providing different types of diffusers.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A window blinds assembly, comprising:
a slat member; and
an LED light strip coupled to the slat member, wherein a light from the LED light strip projects through the slat member.

2. The window blinds assembly of claim 1, comprising an attachment member configured to couple the LED light strip and the slat member.

3. The window blinds assembly of claim 1, wherein the slat member is a diffuser.

4. The window blinds assembly of claim 1, comprising an attachment member for securing the window blinds assembly to a window frame, the attachment member including a channel for disposing a ballast assembly for the LED light strip.

5. The window blinds assembly of claim 4, comprising a pull cord assembly for raising and lowering the window blinds assembly, the pull cord assembly comprising an electrical cord coupling the LED light strip to the ballast assembly.

6. The window blinds assembly of claim 5, wherein the pull cord assembly electrically couples an LED light strip on one slat member to another LED light strip on another slat member.

7. The window blinds assembly of claim 1, wherein the window blind assembly is a vertical blind assembly, a horizontal blind assembly or a roll-up blind assembly.

8. The window blinds assembly of claim 1, comprising a controller coupled to the LED light strip and configured to control an illumination operation of the LED light strip.

9. The window blinds assembly of claim 1, wherein the slat member in combination with the LED light strip forms a window blind.

10. The window blinds assembly of claim 1, wherein the LED light strip is disposed behind the slat member.

11. The window blinds assembly of claim 1, wherein the LED light strip and the slat member are coupled in a spaced apart relationship.

12. A window blinds assembly for covering a window, comprising:
a light diffuser element;
an LED strip coupled to the light diffuser element and configured to project light through the light diffuser;
a pull cord assembly for raising and lowering the window blinds assembly, the pull cord assembly being coupled to the light diffuser element;
an attachment member for coupling the window blinds assembly to a frame portion of the window, the attachment member including a channel for housing a power supply for the LED strip; and
an electrical connection in the pull cord assembly coupling the LED light strip to the power supply.

13. The window blinds assembly of claim 12, wherein the light diffuser element and the LED strip are coupled together to form a blind member for the window blinds assembly, the window blinds assembly comprising a plurality of blind members.

14. The window blinds assembly of claim 12, wherein the window blind assembly is a vertical blind assembly, a horizontal blind assembly or a roll-up blind assembly.

15. The window blinds assembly of claim 12, comprising a controller coupled to the LED light strip and configured to control an illumination operation of the LED light strip.
